(19) United States
(12) Patent Application Publication
(10) Pub. No.: US 2005/0268050 A1
(43) Pub. Date: Dec. 1, 2005

(54) Multi-port memory device providing protection signal

(76) Inventor: Woon-Sik Suh, Yongin-Si (KR)

Correspondence Address: HARNESS, DICKEY & PIERCE, P.L.C., P.O. BOX 8910, RESTON, VA, 20195, US

(21) Appl. No.: 11/050,807

(22) Filed: Feb. 7, 2005

(30) Foreign Application Priority Data
Feb. 7, 2004 (KR) 10-2004-0008176

(51) Int. Cl. G06F 12/00

(52) U.S. Cl. 711/149; 711/151; 711/152

(57) ABSTRACT

A multi-port memory device may provide a protection signal. The multi-port memory device may generate at least one protection signal in response to a bank address signal, in order to control access to the a memory bank, and to suppress access and/or memory collision.

This application claims the priority of Korean Patent Application No. 2004-0008176, filed on Feb. 7, 2004, in the Korean Intellectual Property Office, the disclosure of which is incorporated herein in its entirety by reference.

### BACKGROUND OF THE INVENTION

1. Field of the Invention

The present invention relates to semiconductor memory devices and/or multi-port memory devices.

2. Description of the Conventional Art

A conventional dual port memory device may include a shared memory and input/output devices in, for example, an integrated package. The conventional dual port memory device may read and/or write data to a memory contained therein, for example, in response to a read and/or write signal.

FIG. 1 is a block diagram of an example conventional dual port memory device 100. Referring to FIG. 1, the dual port memory device 100 may include two interfaces 102 and 104, which may be connected to external devices, and a controller 106, which may control signals input/output through the interfaces 102 and 104. The controller 106 may read data stored in a memory 108, and/or write (store) data in the memory 108. The data stored in the memory 108 may be output from the controller 106.

The interfaces 102 and 104 may receive chip-enable signals \overline{CE_{L}} and \overline{CE_{R}}, read/write signals R/\overline{W}_{L} and R/\overline{W}_{R}, address signals A0_{L} through A13_{L} (hereinafter, referred to as a first address signal) and A0_{R} through A13_{R} (hereinafter, referred to as a second address signal), from external devices (not shown), respectively, and may transfer these signals to the controller 106. The controller 106 may analyze the signals and read and/or write the analyzed results as data signals D0_{L} through D7_{L} and/or D0_{R} through D7_{R} to and/or from the memory 108 under the control of the external devices. ‘L’ may represent a left port of the dual port memory device 100, and ‘R’ may represent a right port of the dual port memory device 100.

In the conventional dual port memory device 100, if the first address signal A0_{L} through A13_{L} and the second address signal A0_{R} through A13_{R} received from the external devices are the same, that is, if the external devices request to access the same memory bank in the memory 108, access collision may occur.

### SUMMARY OF THE INVENTION

Example embodiments of the present invention provide a multi-port memory device.

In an example embodiment of the present invention, a multi-port memory device may include a plurality of memory banks, a priority decision unit, and a protection signal generator. The priority decision unit may generate at least one of a first and a second acceptance signal, for example, in response to at least one of a first and a second memory bank selection address. The protection signal generator may generate at least one of a first and a second protection signal, for example, in response to the at least one first and second acceptance signals.

In another example embodiment of the present invention, a multi-port memory device may be adapted to grant or deny access to at least one memory bank by generating at least one of a first and a second acceptance signal. The at least one of the first and second acceptance signal may be based on at least one of a priority and at least one of a first and a second memory bank selection addresses.

In example embodiments of the present invention, the priority decision unit may generate at least one of a first and a second acceptance signal according to a priority. The priority decision unit may store a priority, which may be a hardwired priority. The first and/or the second protection signals may be output to external devices, which may be connected to the multi-port memory device and may inform the external devices of granted access or denied access to the multi-port memory device. In example embodiments of the present invention, the multi-port memory device may be a SDRAM

### BRIEF DESCRIPTION OF THE DRAWINGS

Example embodiments of the present invention will become more apparent by describing in detail the example embodiments thereof with reference to the attached drawings in which:

FIG. 1 is a block diagram of a conventional dual port memory device;

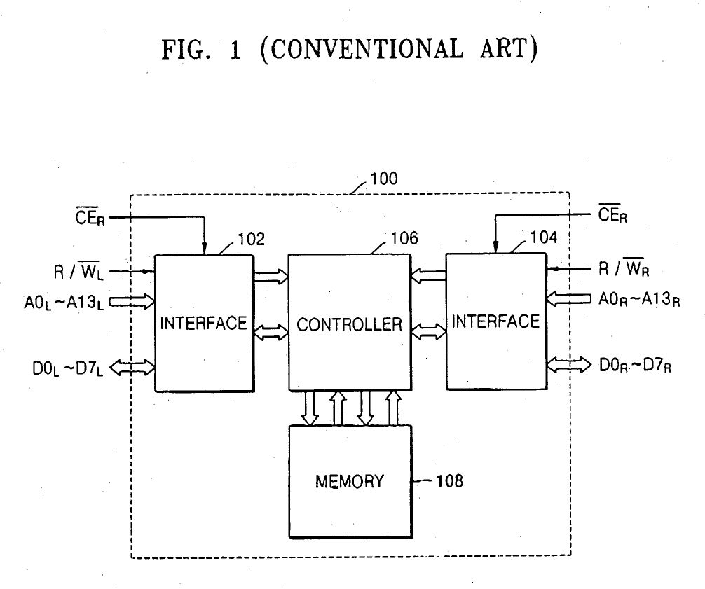

FIG. 2 is a block diagram of a multi-port memory device according to an example embodiment of the present invention; and

FIG. 3 is an example of an operation timing diagram of a multi-port memory device according to an example embodiment of the present invention.

### DETAILED DESCRIPTION OF THE EXAMPLE EMBODIMENTS OF THE PRESENT INVENTION

Example embodiments of the present invention will be described in detail with reference to the appended drawings. Like reference numbers refer to like components throughout the drawings.

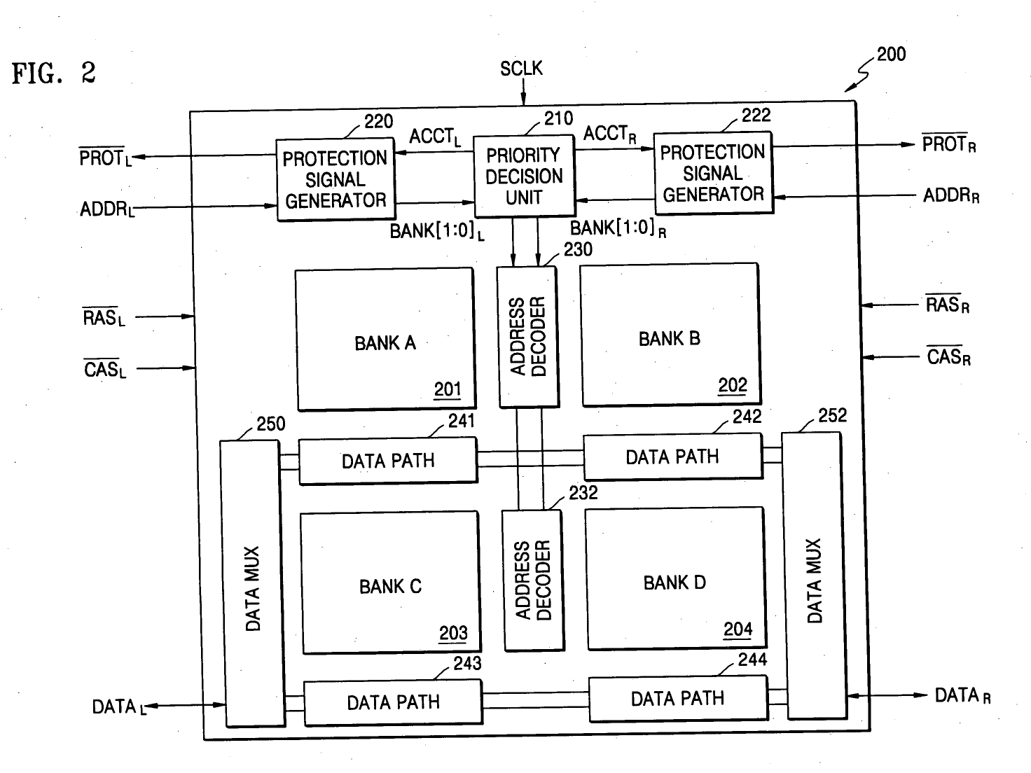

FIG. 2 is a block diagram of an example embodiment of a multi-port memory device 200 according to the present invention. Referring to FIG. 2, the multi-port memory device 200, which may be a synchronous dynamic random access memory (SDRAM), may include a plurality of banks 201, 202, 203, and 204, a priority decision unit 210, protection signal generators 220 and 222, address decoders 230 and 232, data paths 241, 242, 243, and 244, and data MUXs 250 and 252.

The multi-port memory device 200 may receive a system clock SCLK, a first port group and a second port group. The first port group may include a first RAS signal \overline{RAS_{L}}, a first CAS signal \overline{CAS_{L}}, a first address signal ADDR_{L}, a first data signal DATA_{L}, and a first protection signal \overline{PROT_{L}}. The second port group may include a second RAS signal \overline{RAS_{R}}, a second CAS signal \overline{CAS_{R}}, a second address signal ADDR_{R}, a second data signal DATA_{R}, and a second protection signal \overline{PROT_{R}}. The first and second RAS signals \overline{RAS_{L}} and \overline{RAS_{R}}, the first and second CAS signals \overline{CAS_{L}} and \overline{CAS_{R}}, and the first and second address signals ADDR_{L} and ADDR_{R} may be well known to the skilled artisan, and thus, a detailed description thereof has been omitted.

The first and second protection signals \overline{PROT_{L}} and \overline{PROT_{R}} may inform external devices (not shown) of granted access (e.g., access allowance) or denied access (e.g., access disallowance) to the multi-port memory device 200. The first and second protection signals \overline{PROT_{L}} and \overline{PROT_{R}} may be generated by the priority decision unit 210 and the protection signal generators 220 and 222.

The priority decision unit 210 may compare a first bank selection signal BANK[1:0]_{L} with a second bank selection signal BANK[1:0]_{R} in order to determine whether the first bank selection signal BANK[1:0]_{L} and second bank selection signal BANK[1:0]_{R} indicate the same bank (e.g., 201, 202, 203, and/or 204). The first bank selection signal BANK[1:0]_{L} may be included in the first address signal ADDR_{L}, which may be included in the first port group. The second bank selection signal BANK[1:0]_{R} may be included in the second address signal ADDR_{R}, which may be included in the second port group.

If the first bank selection signal BANK[1:0]_{L} and the second bank selection signal BANK[1:0]_{R} do not indicate the same bank, the priority decision unit 210 may generate a first acceptance signal ACCT_{L} and a second acceptance signal ACCT_{R}, which may have the same logic level. For example, the first acceptance signal ACCT_{L} and the second acceptance signal ACCT_{R} may have a higher logic level (e.g., a logic “HIGH” or logic “1”). The first acceptance signal ACCT_{L} and the second acceptance signal ACCT_{R}, which may have the same logic value, may be input to the protection signal generators 220 and 222, respectively. The protection signal generators 220 and 222 may output the first acceptance signal ACCT_{L} and the second acceptance signal ACCT_{R} as first and second protection signals \overline{PROT_{L}} and \overline{PROT_{R}}, respectively. The first and second protection signals \overline{PROT_{L}} and \overline{PROT_{R}} may have the same logic level (e.g., a logic “HIGH” or logic “1”), and external devices (not shown), which may be connected via the first port group and the second port group, may access the multi-port memory device 200.

If the first bank selection signal BANK[1:0]_{L} and the second bank selection signal BANK[1:0]_{R} indicate the same bank, the priority decision unit 210 may selectively generate a first acceptance signal ACCT_{L} and second acceptance signal ACCT_{R}, which may have different logic levels. In example embodiments of the present invention, the first acceptance signal ACCT_{L} or second acceptance signal ACCT_{R} may have a higher logic level (e.g., a logic “HIGH”, or logic “1”) according to a priority (e.g., a hardwired priority).

For example, if the first acceptance signal ACCT_{L} is generated to have a higher logic level (e.g., a logic “HIGH” or logic “1”) and the second acceptance signal ACCT_{R} is generated to have a lower logic level (e.g., logic “LOW” or logic “0”), a first protection signal \overline{PROT_{L}} may be generated to have a higher logic level (e.g., a high logic level or logic level “1”) and a second protection signal \overline{PROT_{R}} may be generated to have a lower logic level (e.g., logic “LOW” or logic “0”). If the first protection signal \overline{PROT_{L}} has a higher logic level an external device, which may be connected via the first port group, may access the multi-port memory device 200, and an external device, Which may be connected via the second port group, may not access the multi-port memory device 200.

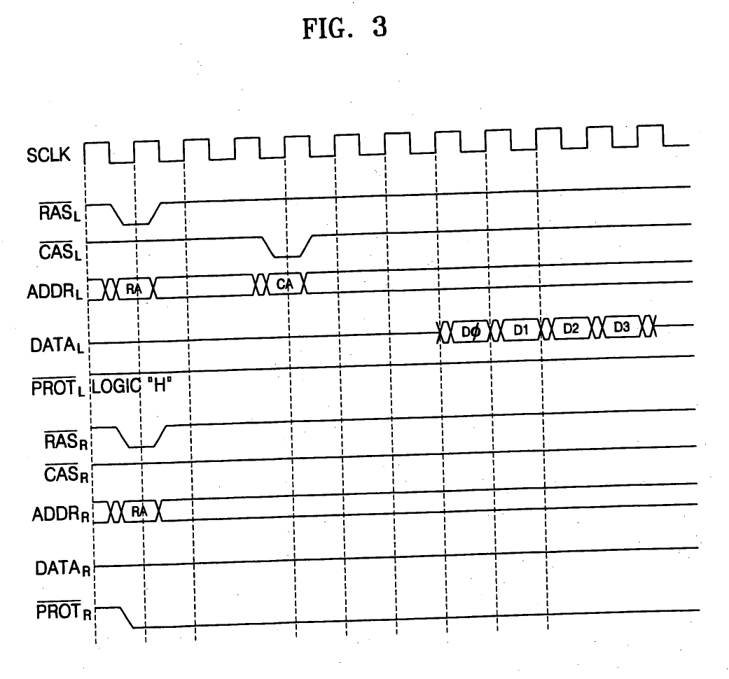

An example of an operation timing diagram of an example embodiment of a multi-port memory device, according to the present invention, is illustrated in FIG. 3. Referring to FIG. 3, a row address RA, which may be input as a first address signal ADDR_{L}, and a first RAS signal \overline{RAS_{L}} may be input to the multi-port memory device 200 in synchronization with a system clock SCLK. The same row address RA, which may be input as a second address signal ADDR_{R}, and a second RAS signal \overline{RAS_{L}} may be input to the multi-port memory device 200 in synchronization with the system clock SCLK. As illustrated in FIG. 3, if the row address RA indicates the same bank (e.g., one of 201, 202, 203, and 204), a first protection signal \overline{PROT_{L}} may remain in a higher logic state (e.g., logic “HIGH” or logic “1”), and a second protection signal \overline{PROT_{R}} may transition to a lower logic state (e.g., logic “LOW” or logic “1”). Data D0 through D3, which may correspond to a burst length, may be output through a first data signal DATA_{L}, which may be included in the first port group, no, or substantially no, data may be input/output through a second data signal DATA_{R}, which may be included in the second port group.

In example embodiments of the multi-port memory device 200 according to the present invention, if first and second address signals ADDR_{L} and ADDR_{R} indicate the same memory bank, granted access to an address signal ADDR_{L} input to one of two ports may suppress memory collision.

As described above, in a multi-port memory device according to example embodiments of the present invention, a protection signal may be generated in response to a priority (e.g., a hardwired priority) and/or a bank address signal, access (e.g., simultaneous access) to the same memory bank may be controlled, and access or memory collision may be suppressed.

Although example embodiments of the present invention have been described with regard to SDRAM, it will be understood that example embodiments of the present invention may be utilized in connection with any suitable memory device, for example, dynamic random access memory (DRAM), random access memory (RAM), read only memory (ROM), or the like.

Although example embodiments of the present invention have been described with respect to higher logic levels (e.g., logic “1”), and lower logic levels (e.g., “0”), it will be understood that any suitable logic level may be used and/or these higher logic levels may be interchangeable.

Although example embodiments of the present invention have been described with regard to memory banks (e.g., 201-204), it will be understood that example embodiments of the present invention may be used in connection with any suitable memory location or the like.

Although example embodiments of a multi-port memory device, according to the present invention, have been described with respect to a multi-port memory device with 2 ports, it will be understood that example embodiments of the multi-port memory device may have any suitable number of ports, for example, 2 or more ports.

While example embodiments of the present invention have been particularly shown and described with reference to the example embodiments thereof, it will be understood by those of ordinary skill in the art that various changes in form and details may be made therein without departing from the spirit and scope of the present invention as defined by the following claims.

1. A multi-port memory device comprising:
a plurality of memory banks;
a priority decision unit generating at least one of a first and a second acceptance signal, in response to at least one of a first and a second memory bank selection addresses; and
a protection signal generator generating at least one of a first and a second protection signal, in response to at least one of a first and a second acceptance signal.

2. The multi-port memory device of claim 1, wherein the at least one of the first and the second acceptance signal is generated according to a priority.

3. The multi-port memory device of claim 2, wherein the priority is a hardwired priority.

4. The multi-port memory device of claim 3, wherein the priority decision unit stores the hardwired priority.

5. The multi-port memory device of claim 1, wherein each of the first and second protection signals is provided to each of a plurality of external devices connected to the multi-port memory device and informs each of the plurality of external devices of granted access or denied access to the multi-port memory device.

6. The multi-port memory device of claim 1, wherein the multi-port memory device is an SDRAM.

7. A multi-port memory device adapted to grant or deny access to at least one memory bank by generating at least one acceptance signal based on at least one of plurality of memory bank selection address.

8. The multi-port memory device of claim 7, wherein the at least one acceptance signal is generated according to a priority.

9. The multi-port memory of claim 6, further including,
a plurality of memory banks;
a priority decision unit generating the at least one acceptance signal; and
a protection signal generator generating at least one protection signal, in response to the at least one acceptance signal.

10. The multi-port memory device of claim 9, wherein the priority is a hardwired priority.

11. The multi-port memory device of claim 10, wherein the priority decision unit stores the hardwired priority.

12. The multi-port memory device of claim 8, wherein each of a plurality of protection signals is provided to each of a plurality of external devices connected to the multi-port memory device and informs each of the plurality of external devices of granted access or denied access to the multi-port memory device.

13. The multi-port memory device of claim 7, wherein the multi-port memory device is an SDRAM.
